(19) United States
(12) Patent Application Publication
(10) Pub. No.: US 2021/0170298 A1
(43) Pub. Date: Jun. 10, 2021

(54) PROCESS FOR RECOVERING SOLVENT AND PURIFYING PRODUCT

(71) Applicant: Hebeler Process Solutions, LLC, Tonawanda, NY (US)

(72) Inventors: Todd E. MURRAY, Sanborn, NY (US); Maliek F. LIKELY, Buffalo, NY (US); Kelly M. CARMINA, Lockport, NY (US)

(21) Appl. No.: 17/103,051

(22) Filed: Nov. 24, 2020

Related U.S. Application Data
(60) Provisional application No. 62/944,693, filed on Dec. 6, 2019.

(51) Int. Cl. B01D 1/28; C11B 9/02

(52) U.S. Cl. CPC B01D 1/284; B01D 1/289; C11B 9/025

(57) ABSTRACT

Embodiments may include methods and systems for purifying a product and recovering a solvent. In a first stage, a raw feed comprising an initial solvent fraction and an initial product fraction may be heated using a first heat exchanger, and an intermediate vapor fraction of the initial solvent fraction may be vaporized using a first vapor liquid separator to yield an intermediate product comprising intermediate solvent and intermediate product fractions. The intermediate vapor fraction may be condensed to a first solvent condensate using a first condenser. In a second stage, the intermediate product may be heated using a second heat exchanger, and a final vapor fraction of the intermediate solvent fraction may be vaporized using a second vapor liquid separator to yield a purified product comprising final solvent and final product fractions. The final vapor fraction may be condensed to a second solvent condensate using a second condenser.

### CROSS REFERENCE TO RELATED APPLICATIONS

This application claims priority to U.S. Provisional Application No. 62/944,693, filed on Dec. 6, 2019, the entire disclosure of which is hereby incorporated by reference.

### FIELD OF THE DISCLOSURE

The disclosure relates to solvent-product separation systems.

### BACKGROUND OF THE DISCLOSURE

Current methods and systems for product purification lack efficiency and effectiveness. Therefore, improved methods and systems are needed.

### SUMMARY OF THE INVENTION

In an instance, a method may purify a product and recover a solvent.

The method may comprise, at a first heat exchanger, receiving a raw feed, which may comprise an initial solvent fraction and an initial product fraction, and heating the raw feed to produce a heated raw feed.

The method may further comprise, at a first vapor liquid separator, receiving the heated raw feed, and vaporizing at least an intermediate vapor fraction of the initial solvent fraction such that the intermediate vapor fraction separates from the heated raw feed, which may thereby yield an intermediate product, which may comprise an intermediate solvent fraction and an intermediate product fraction.

The method may further comprise, at a first condenser, condensing the intermediate vapor fraction, which may thereby yield a first solvent vapor condensate.

The method may further comprise, at a second heat exchanger, receiving the intermediate product and heating the intermediate product to produce a heated intermediate product.

The method may further comprise, at a second vapor liquid separator, receiving the heated intermediate product and vaporizing at least an final vapor fraction of the intermediate solvent fraction such that the final vapor fraction may separate from the heated intermediate product, which may thereby yield a purified product comprising a final solvent fraction and a final product fraction.

The method may further comprise, at a second condenser, condensing the final vapor fraction, which may thereby yield a second solvent condensate.

The method may further comprise recirculating a portion of the intermediated product into the first heat exchanger.

The method may further comprise recirculating a portion of the purified product into the second heat exchanger.

The method may further comprise generating, using a vacuum system, which may include a vacuum pump, a negative pressure at a solvent-contacting side of the second condenser.

The raw feed may comprise ethanol and/or cannabis oil.

The initial solvent fraction may be 95 percent ethanol and/or the initial product fraction may be 5% oils.

The intermediate solvent fraction may be 70 percent ethanol and/or the intermediate product fraction may be 30 percent oils.

The final solvent fraction may be 0.5 percent ethanol and/or the final product fraction may be 99.5 percent oils.

The first heat exchanger may receive the raw feed at an average rate of at least 390 L/hr.

The second heat exchanger may receive the intermediate feed at an average rate of at least 65 L/hr.

A temperature of the raw feed may be 25 degrees Celsius.

A temperature of the intermediate product may be 82 degrees Celsius.

The first vapor liquid separator may vaporize the intermediate vapor fraction at a rate of 325 L/hr.

The second vapor liquid separator may vaporize the final vapor fraction at an average rate of 36 L/hr.

In an instance, a product purification and solvent recovery system may comprise a system cooling source inlet, a system chilled source inlet, a system energy source inlet, a raw feed inlet, a first stage, a second stage, a final product discharge outlet and a final solvent discharge outlet.

The first stage may include a first heat exchanger, a first vapor liquid separator, and a first condenser.

The first heat exchanger may have a first heat exchanger feed inlet, which may in fluid communication with the raw feed inlet. The first heat exchanger may further have a first heat exchanger energy inlet in fluid communication with the system energy source inlet. The first heat exchanger may further include a first heat exchanger feed outlet.

The first vapor liquid separator may have a first vapor liquid separator, which may be in fluid communication with the first heat exchanger feed outlet. The first vapor liquid separator may further have a first solvent vapor outlet. The first vapor liquid separator may further have an intermediate product drain.

The first condenser may have a first cooling source inlet, which may be in fluid communication with the system cooling source inlet. The first condenser may further have a first solvent vapor inlet, which may be in fluid communication with the first solvent vapor outlet of the first vapor liquid separator. The first condenser may further have a first solvent condensate outlet.

The second stage may include a second heat exchanger, a second vapor liquid separator, and a second condenser.

The second heat exchanger may have a second heat exchanger feed inlet, which may be in fluid communication with the intermediate product drain. The second heat exchanger may further have a second heat exchanger energy inlet, which may be in fluid communication with the system energy source inlet. The second heat exchanger may further have a second heat exchanger feed outlet.

The second vapor liquid separator may have a second vapor liquid separator inlet, which may be in fluid communication with the second heat exchanger feed outlet. The second vapor liquid separator may further have a second solvent vapor outlet. The second vapor liquid separator may further have a second solvent condensate outlet.

The second condenser may have a second cooling source, which may be in fluid communication with the system chilled source inlet. The second condenser may further have a second solvent vapor inlet, which may be in fluid communication with the second solvent vapor outlet the second condenser may further have a second solvent condensate outlet.

The final product discharge outlet may be in fluid communication with the purified product drain.

The final solvent discharge outlet may be in fluid communication with the first solvent condensate outlet and the second solvent condensate outlet.

The second condenser may have a vacuum draw outlet. The second stage may further comprise a vacuum pump. The vacuum pump inlet may have a vacuum pump inlet, which may be in fluid communication with the vacuum draw outlet.

The first stage may further comprise a recirculation pump. The recirculation pump may have a recirculation pump inlet, which may be in fluid communication with the intermediate product drain. The recirculation pump may further have a recirculation pump outlet, which may be in fluid communication with the first heat exchanger feed inlet.

The first heat exchanger may be a plate and frame heat exchanger, a brazed plate heat exchanger, a shell and tube heat exchanger, a spiral heat exchanger, or a plate and shell heat exchanger. The second heat exchanger may be a plate and frame heat exchanger, a brazed plate heat exchanger, a shell and tube heat exchanger, a spiral heat exchanger, or a plate and shell heat exchanger.

The first condenser may be a plate and frame heat exchanger, a brazed plate heat exchanger, a shell and tube heat exchanger, a spiral heat exchanger, or a plate and shell heat exchanger. The second condenser may be a plate and frame heat exchanger, a brazed plate heat exchanger, a shell and tube heat exchanger, a spiral heat exchanger, or a plate and shell heat exchanger.

The first vapor liquid separator may be a dished head separator. The second vapor liquid separator may be a dished head separator.

The first vapor liquid separator may have a mist eliminator. The second vapor liquid separator may have a mist eliminator.

### BRIEF DESCRIPTION OF THE FIGURES

For a fuller understanding of the nature and objects of the disclosure, reference should be made to the following detailed description taken in conjunction with the accompanying drawings, in which:

FIG. 1 is a process flow diagram for an embodiment system;

FIG. 2 illustrates an embodiment first stage separator;

FIG. 3 illustrates an embodiment second stage separator; and

FIG. 4A is a piping and instrumentation diagram (P&ID) representing an example first stage embodiment; and

FIG. 4B is a P&ID representing an example second stage embodiment.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein include methods and systems for processing a raw feed to yield recovered solvent and purified product. Such systems may be used, for example, to separate a solvent (e.g., ethanol, etc.) from an oil (e.g., cannabis oil, etc.).

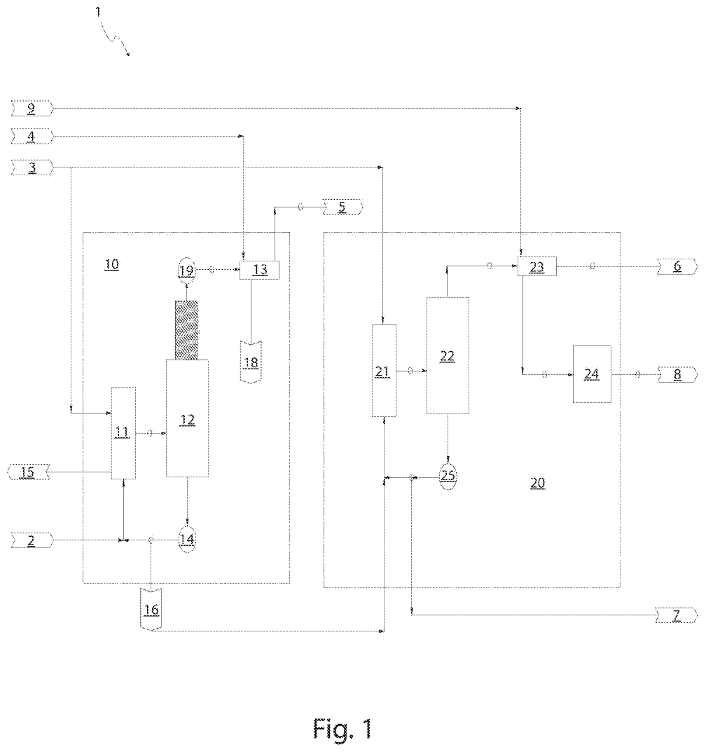

FIG. 1 depicts a process flow diagram for a system 1. The system 1 may have a raw feed inlet 2, an energy inlet 3, a cooling inlet 4, and a chilled cooling inlet 9. The system 1 may also have a final product discharge outlet 7 and a final solvent discharge outlet (not depicted) in fluid communication with a first solvent condensate outlet 5 and a second solvent condensate outlet 6.

The system 1 may comprise two stages: a first stage 10 and a second stage 20.

At the first stage 10, a raw feed comprising an initial solvent fraction and an initial product fraction may enter at the raw feed inlet 2 and be received at a first heat exchanger 11. At the first heat exchanger 11, which may be operatively in fluid communication with the energy inlet 3, the raw feed may be heated to produce a heated raw feed.

The heated raw feed may then be received at a first vapor liquid separator 12. At the first vapor liquid separator 12, at least an intermediate vapor fraction of the initial solvent fraction may be vaporized such that the intermediate vapor fraction separates from the heated raw feed. In this way, an intermediate product comprising an intermediate solvent fraction and an intermediate vapor fraction may be produced.

The intermediate vapor fraction may be discharged from the first vapor liquid separator 12 and be received at a first condenser 13. The first condenser 13 may be operatively in fluid communication with the cooling inlet 4. At the first condenser 13, the intermediate vapor fraction may be condensed to yield a first solvent condensate, which may be discharged at the first solvent condensate outlet 5.

In some embodiments, the intermediate product is recirculated using a recirculation pump 14 into the first heat exchanger 11 to further purify the intermediate product.

The intermediate product may exit the first stage 10 and enter the second stage 20 either via a direct connection or a piping run. In some embodiments a pump may be operatively connected to the piping run to pump the intermediate product from the first stage 10 to the second stage 20.

At the second stage 20, the intermediate product may be received at a second heat exchanger 21. At the second heat exchanger 21, which may be operatively in fluid communication with the energy inlet 3, the intermediate product may be heated to produce a heated intermediate product.

The heated intermediate product may then be received at the second vapor liquid separator 22. At the second vapor liquid separator 22, at least a final vapor fraction of the intermediate solvent fraction may be vaporized such that the final vapor fraction separates from the heated intermediate product. In this way, a purified product comprising a final solvent fraction and a final vapor fraction may be produced.

The final vapor fraction may be discharged from the second vapor liquid separator 22 and be received at the second condenser 23. The second condenser 23 may be operatively in fluid communication with the chilled cooling inlet 9. In the second condenser 23, the final vapor fraction may be condensed to yield a second solvent condensate, which may be discharged at the second solvent condensate outlet 6.

The purified product may be discharged from the system at the final product discharge outlet 7.

In some embodiments, a vacuum pump 24 is operatively in fluid communication with the solvent side of the condenser 23 to pull vacuum on the solvent side of the condenser. The vacuum pump 24 may vent to atmosphere at a vent 8.

In some embodiments, the final product is recirculated using a recirculation pump 25 into the second heat exchanger 21 with the intermediate feed to further purify it.

The system 1 may operate continuously, so as to take continuous raw feed input and provide continuous recovered solvent and intermittent or continuous purified product output. In other embodiments, the system 1 may operate in a batch or semi-batch fashion.

In some embodiments where continuous processing is performed by the system 1, operation may proceed as follows. The first stage 10 may process raw feed to a high level of intermediate feed in the first vapor liquid separator 12. The first stage 10 may discharge intermediate material to the second stage 20 until a low level in the first vapor liquid separator 12 is reached, stopping flow from the first stage 10 to the second stage 20. The second stage 20 may further process and concentrate the intermediate material to a concentrated product. The raw feed to the first stage 10 may continue and the first stage 10 may continue to process raw feed until again the intermediate feed reaches the high level in the first vapor liquid separator 12, and then again the intermediate feed may be discharged to the second stage 20. During the time the intermediate feed discharge to the second stage 20 lapses, the second stage 20 may enter a polish mode for a determined time to process the concentrated product into a purified product. Once the final concentration of the purified product is reached in the second vapor liquid separator 22, the second stage 20 may discharge the purified product. Once the second stage 20 discharges a portion of the purified product, the discharge of intermediate product from the first stage 10 to the second stage 20 may resume. This cycle may be repeated to effect continuous processing by the system 1.

Various components of the first stage 10 and the second stage 20 may be connected (e.g., in fluid communication) using pipes or tubes. Connections may further comprise flanges and welded connections. Such pipes, tubes, or connections, while preferably metal, may be made of various materials including, for example plastics, depending on the process parameters of the system. For sanitary or food processing applications, such pipes or tubes may be made of stainless steel, for example American Society of Mechanical Engineers (ASME) Grade SA-304, SA-304L, SA-316, or SA-316L (or the equivalent American Society for Testing and Materials (ASTM) grades). Various process components (e.g., evaporators, heat exchangers, separators, condensers) may be made of appropriate materials for the process application. For example, for food service a plate and frame heat exchanger may have carbon steel front and back heads, but have stainless steel heat transfer plates. Likewise, a shell and tube heat exchanger, for example, may have a carbon steel shell, but have a stainless steel bonnet/channel, tubesheet, head(s), and tubes. Tubes in a shell-and-tube heat exchanger may be, for example, straight or u-tubes, and may be smooth or finned (e.g., hi-fin or bo-fin).

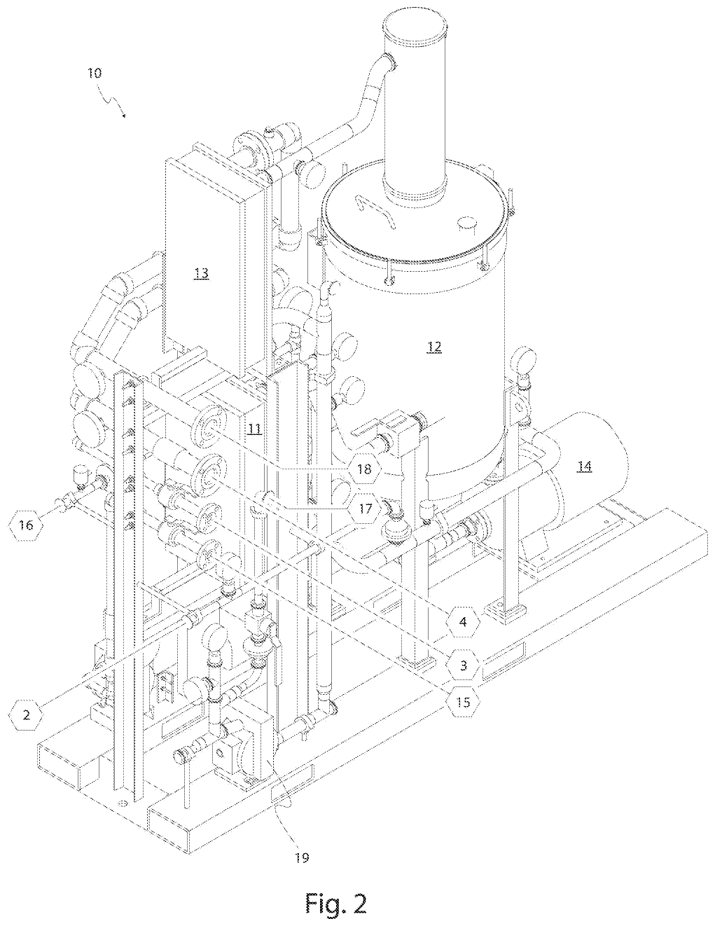

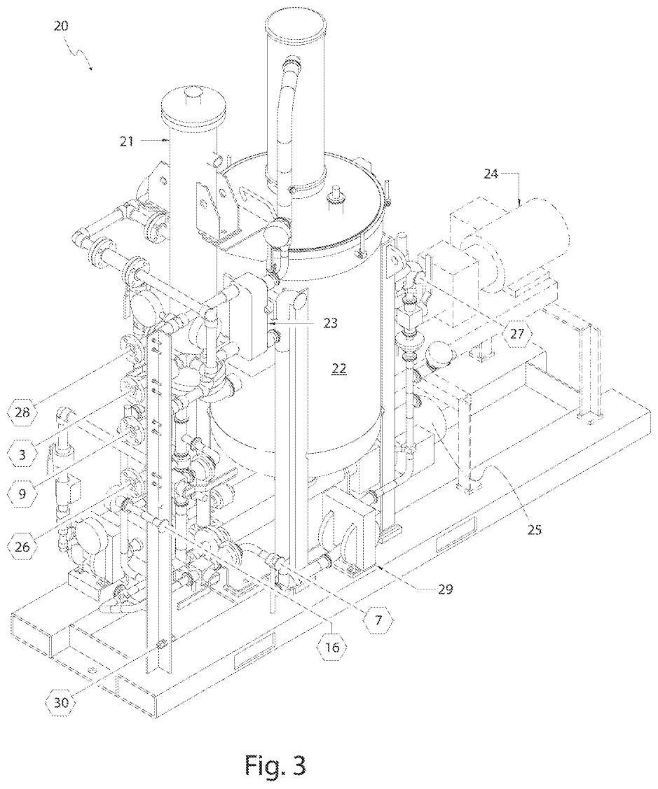

FIG. 2 and FIG. 3 depict a first stage 10 and a second stage 20 of an example embodiment system.

A first heat exchanger 11 may be have a “hot” side and a “cold” side. It should be noted that heat exchangers are commonly referred to as having “sides.” This means that between each side's inlet and outlet, there is a path for a fluid that does not come into fluid communication with a path for another fluid on another side of the heat exchanger. The two sides are designed so as to optimize heat transfer between two fluids based on specific application parameters. Some designs may include the use of a shell for one fluid to pass through and tubes within the shell for the other fluid to pass through, enabling heat transfer from the hot side to the cold side. Other designs may include the use of thermal plates, where different fluids pass down either side of a thermal plate in a plate stack (alternating every other, every third, etc.), enabling heat transfer from the hot side to the cold side. One fluid is considered an energy source (e.g., having a higher thermal energy relative to another fluid), and the other is the fluid to be energized, thus exhibiting heat transfer from the energy source to the energized fluid. Thus, describing one side as “hot” and the other as “cold” should thus not be taken to describe the temperatures at all places in a particular side of a heat exchanger. The hot side may have an inlet and outlet, and the cold side may have an inlet and outlet. The hot side inlet may be a first energy source inlet, and may be in fluid communication with an energy inlet 3. The cold side inlet may be a first heat exchanger feed inlet, and may be in fluid communication with a raw feed inlet 2 or any intermediate.

As the raw feed passes through the cold side of the first heat exchanger 11 and the energy source (e.g., steam, hot oil, etc.) passes through the hot side, heat may be transferred from the hot side to the cold side, thereby heating the raw feed. The heated raw feed may pass out of the first heat exchanger 11 via a first heat exchanger feed outlet.

The first heat exchanger 11 may be, for example, a plate and frame, shell and tube, brazed plate, spiral, or plate and shell heat exchanger. Preferably, the first heat exchanger 11 is a plate and frame heat exchanger. There may be an energy return outlet 15 in fluid communication with the hot side of first heat exchanger 11. Use of a plate and frame heat exchanger in the first stage offers a compact system, which may increase effectiveness in meeting the higher capacity production requirements under atmospheric conditions. This system may recover a reusable solvent (e.g., ethanol, etc.) overhead, while concentrating a product. Performance advantages of embodiments provided herein include: compact equipment arrangements, flexibility for low throughput requirements, high heat transfer efficiency, high velocities to minimize fouling, no need for chilled water, and no need for vacuum equipment.

A first vapor liquid separator 12 may have a first vapor liquid separator inlet, which may be in fluid communication with the first heat exchanger feed outlet. The first vapor liquid separator 12 may additionally have a first solvent vapor outlet and an intermediate product drain 16. The intermediate product drain 16 may function as an outlet for an intermediate product, which is the portion of the heated raw feed/intermediate or any mixture that is not vaporized, to pass out of the first stage 10. The intermediate product drain 16 may allow intermediate product to pass out of the first stage 10 by gravity or pressure differential, or the intermediate product may be pumped out of the first stage 10.

The first vapor liquid separator 12 may be a dished head separator, and may have a vane style mist eliminator.

A first condenser 13 may be a heat exchanger having a hot side and a cold side. The hot side may have an inlet and outlet, and the cold side may have an inlet and outlet. The hot side inlet of the first condenser 13 may be a first solvent vapor inlet in fluid communication with the first solvent vapor outlet of the first vapor liquid separator 12. The cold side inlet of the first condenser 13 may be a first cooling source inlet in fluid communication with a cooling inlet 4. The first condenser 13 may have a first solvent condensate outlet 17 and a cooling water return outlet 18.

The first condenser 13 may be, for example, a plate and frame, shell and tube, brazed plate, spiral, or plate and shell heat exchanger. Preferably, the first condenser 13 is a plate and frame heat exchanger. A condenser pump 19 may operate to pump first solvent condensate from the first condenser 13. The condenser pump 19 may be, for example, a manual, air-operated, diaphragm (e.g., AOD) pump.

In some embodiments, the first stage 10 may further comprise a recirculation pump 14. The recirculation pump 14 may be in fluid communication with the intermediate product drain and the first heat exchanger 11 feed inlet. The recirculation pump 14 may have, for example, a 3.0 horsepower motor. Using the recirculation pump 14, all or a portion of an intermediate product may be recirculated through the first stage 10 in order to further separate solvent from the intermediate product.

A second heat exchanger 21 may have a hot side and a cold side. The hot side may have an inlet and outlet, and the cold side may have an inlet and outlet. The hot side inlet may be a second energy source inlet, and may be in fluid communication with the energy inlet 3. The cold side inlet may be in fluid communication with a second heat exchanger feed inlet, which may be in fluid communication with the intermediate product drain 16.

As the intermediate feed passes through the cold side of the second heat exchanger 21 and the energy source passes through the hot side, heat may be transferred from the hot side to the cold side, thereby heating the intermediate product feed. The heated intermediate product feed may pass out of the second heat exchanger 21 via a second heat exchanger feed outlet.

The second heat exchanger 21 may be, for example, a plate and frame, shell and tube, brazed plate, spiral, or plate and shell heat exchanger. Preferably, the second heat exchanger 21 is a shell and tube heat exchanger. There may be an energy return outlet 26 from the second heat exchanger 21.

A second vapor liquid separator 22 may have a second vapor liquid separator inlet, which may be in fluid communication with the second heat exchanger feed outlet. The second vapor liquid separator 22 may additionally have a second solvent vapor outlet and a purified product drain. The purified product drain may function as an outlet for purified product, which is the portion of the heated intermediate feed that is not vaporized, to pass out of the second stage 20. The purified product drain may allow purified product to pass out of the second stage 20 by gravity, or the purified product may be pumped out of the second stage 20.

The second vapor liquid separator 22 may be a dished head separator, and may have a vane style mist eliminator.

A second condenser 23 may be a heat exchanger having a hot side and a cold side. The hot side may have an inlet and outlet, and the cold side may have an inlet and outlet. The hot side inlet of the second condenser 23 may be a second solvent vapor inlet in fluid communication with second solvent vapor outlet of the second vapor liquid separator 22. The cold side inlet of the second condenser 23 may be a second cooling source inlet in fluid communication with chilled cooling inlet 9. The second condenser 23 may have a second solvent condensate outlet 27 and a cooling water return outlet 28.

The second condenser 23 may be, for example, a plate and frame, shell and tube, brazed plate, spiral, or plate and shell heat exchanger. Preferably, the second condenser 23 is a brazed plate heat exchanger. A condenser pump 29 may operate to pump second solvent condensate from the second condenser 23. The condenser pump 29 may be, for example, a manual, AOD pump.

A final product discharge outlet 7 may be in fluid communication with the purified product drain.

The final solvent discharge outlet 6 may be in fluid communication with the first solvent condensate outlet 17 and the second solvent condensate outlet 27.

The second stage may operate under vacuum conditions to achieve higher product concentration and lower operating temperatures as opposed to operating atmospherically. As more concentrated material may have a higher viscosity, a rising-falling film evaporator may be required. In some embodiments, the second stage 20 may further comprise a vacuum sub-system including a vacuum pump 24 having a vacuum pump inlet may be present and in fluid communication with the second condenser 23 via a vacuum draw outlet on the solvent side.

In some embodiments, the second stage 20 may further comprise recirculation pump 25. The recirculation pump 25 may be in fluid communication with the purified product drain and the second heat exchanger feed inlet. The recirculation pump 25 may have, for example, a 2.0 horsepower motor. Using the recirculation pump 25, all or a portion of an intermediate product may be recirculated through the second stage 20 in order to further separate solvent from the intermediate product.

Various pressure, temperature, and level gauges and transmitters may be employed at various points in the system 1. An instrument air supply line may supply air necessary to operate various instruments on the device. The instrument air supply line may have an inlet 30. The instrument air supply line may be supplied with instrument air at, for example, a pressure of 80 pounds per square inch in gauge (psig), at a −40 degree Celsius dew point, and oil-free.

The process feed flowrate may be manually adjusted and directed into each heat exchanger. The energy feed may be regulated to each evaporator, thus controlling the rate of vaporization. Discharge from each evaporator may be directed into each vapor liquid separator. From the vapor liquid separator, liquid may be partially recirculated by, for example, by a magnetically-driven centrifugal pump.

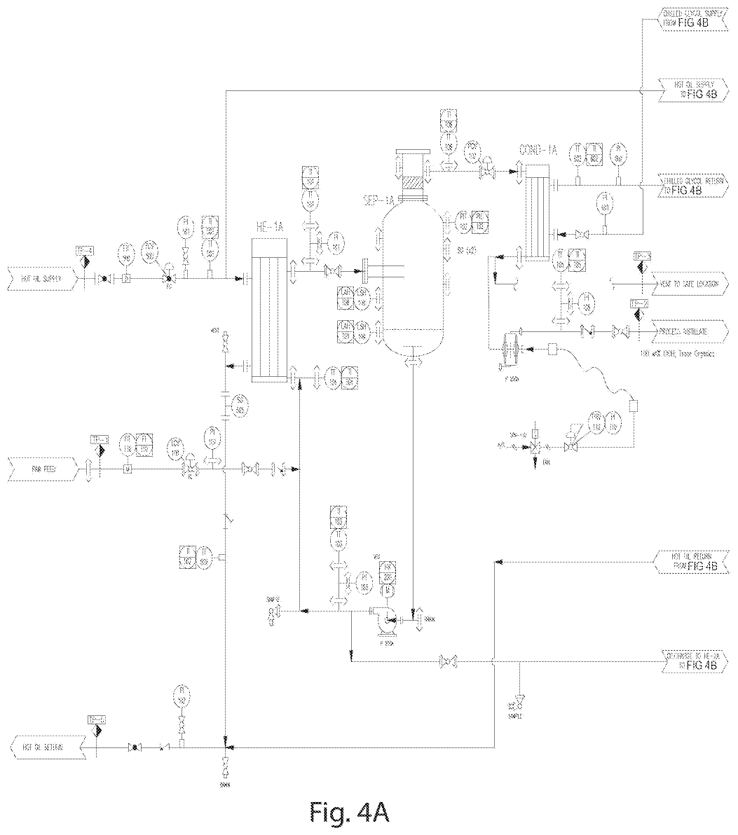

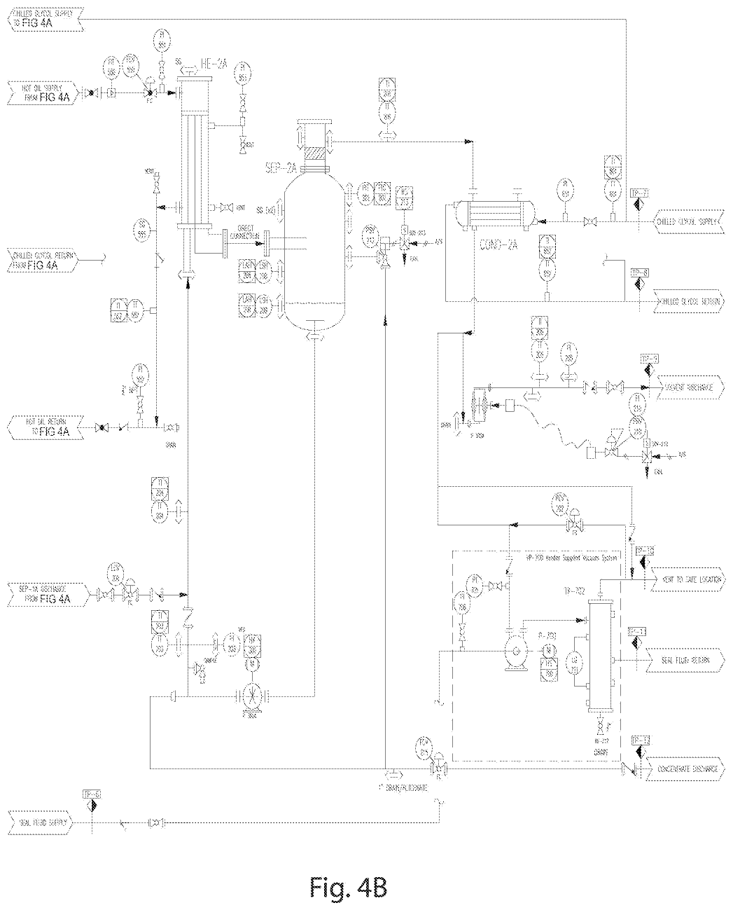

FIGS. 4A and 4B are a piping and instrumentation diagram (P&ID) of an example embodiment. In FIG. 4, the following abbreviations are used to designate the various components: COND stands for condenser, FCV stands for flow control valve, FI stands for flow indicator, FIT stands for flow indicator transmitter, HE stands for heat exchanger, HK stands for hand control, HS stands for hand switch, HV stands for hand valve, LAH stands for level alarm (high), LCV stands for level control valve, LG stands for level gauge, LSH stands for level switch (high), M stands for motor, P stands for pump, PCV stands for pressure control valve, PI stands for pressure indicator, PIC stands for pressure indicator controller, PIT stands for pressure indicator transmitter, PRV stands for pressure regulator valve, PSV stands for pressure safety valve, S stands for solenoid, SEP stands for separator, SG stands for sight glass, SOV stands for solenoid orifice valve, TI stands for temperature indicator, TP stands for tie point, TT stands for temperature transmitter, VP stands for vacuum pump system. Some of the components have a number associated with the abbreviation—this number is a designation of the particular component. Line continuation markers are shown to where each stage interfaces with the other stage or external process connection tie points.

In an example embodiment, an ethanol solvent is separated from cannabis oil. Process parameters may vary from those disclosed herein, and thus the process parameters disclosed herein should not be read as limiting in any way. Depending on a particular application, the process parameters may be scaled up or down, or otherwise changed to suit a particular application. At the raw feed inlet, a raw feed having an initial fraction of ethanol solvent and an initial fraction of cannabis oil may be received. The initial fraction of ethanol solvent may be 95% of the raw feed. The initial fraction of cannabis oil may be 5% of the raw feed. The temperature of the raw feed may be 25 degrees Celsius. The feed rate of the raw feed entering the first stage may be 390 L/hr.

The first stage may operate at atmospheric pressure. The first heat exchanger may evaporate a first vapor fraction of the ethanol solvent in the raw feed at a rate of 325 L/hr. The hot side of the first heat exchanger may be operated with steam at 285 lb/hr at 40 pounds per square inch absolute (psia). In this way, the composition of the intermediate vapor fraction may be 99.95% ethanol and trace oils (a maximum of 0.1% oils).

The first vapor liquid separator may enable the intermediate vapor fraction to separate from the raw feed, yielding the intermediate product. The intermediate product may comprise 70% ethanol and 30% oils discharged from the first vapor liquid separator at an average rate of 65 L/hr.

The first condenser may condense the intermediate vapor fraction (distillate) on the hot side of the first condenser using cooling water on the cold side of the first condenser. The cooling water may flow at a rate of 7.26 m\hat{ }3/hr at 25 degrees Celsius.

The intermediate product may pass from the first stage to the second stage. The temperature of the intermediate product may be 82 degrees Celsius. The average feed rate of the intermediate feed entering the second stage may be 65 L/hr, the discharge rate from the first stage.

The second stage may operate at a pressure of 103 mmHg absolute. The second heat exchanger may evaporate a final vapor fraction of the ethanol solvent in the intermediate feed at an average rate of 36 L/hr. The hot side of the second heat exchanger may be operated with steam at 23 lb/hr at 40 psia. In this way, the composition of the final vapor fraction may be 99.95% ethanol and trace oils (a maximum of 0.1% oils).

The second vapor liquid separator may enable the final vapor fraction to separate from the intermediate product, yielding the purified product. The purified product may comprise 0.5% ethanol and 99.5% oils discharged from the second vapor liquid separator at a rate of 15.4 L/hr.

The second condenser may condense the final vapor fraction (distillate) on the hot side of the second condenser using chilled water on the cold side of the second condenser. The chilled water may flow at a rate of 2.46 m\hat{ }3/hr at 10 degrees Celsius.

The purified product, comprising 99.5% cannabis oil and 0.5% ethanol solvent, may be collected from the second stage. With this concentration, the purified product may meet the Food and Drug Administration (FDA) guidelines for human consumption, which may alleviate the need to further process the purified product once it leaves the second stage. The recovered solvent, comprising 99.95% ethanol and trace oils (a maximum of 0.1% oils) may be collected from the first and second condensers.

In a further example embodiment where continuous processing is performed by the system, operation may proceed as follows. The first stage may process raw feed (5% oil and 95% solvent) to a high level of intermediate feed (30% oil and 70% solvent) in the first vapor liquid separator. The first stage may discharge intermediate material to the second stage until a low level in the first vapor liquid separator is reached stopping flow from the first stage to the second stage. This discharge may occur for 20 minutes. The second stage may further process and concentrate the intermediate material to a concentrated product (65% oil and 35% solvent). The raw feed to the first stage may continue and the first stage 10 may continue to process raw feed (from 5% oil to 30% oil) until the intermediate feed again reaches the high level in the first vapor liquid separator, and then again the intermediate feed may be discharged to the second stage. During the time the intermediate feed discharge to the second stage lapses, the second stage may enter a polish mode a determined time (e.g., 60 minutes) to process the concentrated product into a purified product (99.5% oil and 0.5% solvent). Once the final concentration of the purified product is reached in the second vapor liquid separator, the second stage may discharge the purified product, for example, for 15 minutes. Once the second stage discharges a portion of the purified product, the discharge of intermediate product from the first stage to the second stage may resume. This cycle may be repeated to effect continuous processing by the system.

The systems and methods herein have advantages over prior separation systems and methods both in efficiency and in effectiveness. Efficiency of product separation and solvent recovery is increased due to a lesser demand for external power (the heat energy source and electricity), as the processing of the output of the first stage by the second stage alleviates the need for a vacuum draw and chilled water on the first stage.

Inclusion of the first stage before the second stage may increase production capacity of a high oil concentration by three and one-half times compared to using the second stage alone. Use of the second stage may alleviate the need for larger equipment when processing a large raw feed volume and may allow for the versatility to also process low volumes without changing equipment. Much of the solvent (e.g., alcohol) may be recovered at the first stage for reuse. The vapor liquid separators of the first and second stage may be compatible with rectification for further purification, combining downstream purification with solvent recovery. Only a small chiller may be required for the second stage condenser, as cooling water itself may be sufficient for the first stage condenser. The second stage further may provide the ability to decarboxylate the product, combining downstream decarboxylation with solvent recovery. The additional holding volume of the system may permit additional processing flexibility. The first stage may operate as a forced circulation design to optimize solvent (e.g., alcohol) removal, while the second stage may operate in a rising-falling design to more delicately handle heat-sensitive product. The system may further provide the option of operation in continuously-fed, semi-batch, or batch operation.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

Although the present disclosure has been described with respect to one or more particular embodiments, it will be understood that other embodiments of the present disclosure may be made without departing from the scope of the present disclosure.

What is claimed is:

1. A method to purify a product and recover a solvent comprising:
at a first heat exchanger:
receiving a raw feed comprising an initial solvent fraction and an initial product fraction, and
heating the raw feed to produce a heated raw feed;
at a first vapor liquid separator:
receiving the heated raw feed, and
vaporizing at least an intermediate vapor fraction of the initial solvent fraction such that the intermediate vapor fraction separates from the heated raw feed, thereby yielding an intermediate product comprising an intermediate solvent fraction and an intermediate product fraction;
at a first condenser:
condensing the intermediate vapor fraction, thereby yielding a first solvent condensate;
at a second heat exchanger:
receiving the intermediate product, and
heating the intermediate product to produce a heated intermediate product;
at a second vapor liquid separator:
receiving the heated intermediate product, and
vaporizing at least a final vapor fraction of the intermediate solvent fraction such that the final vapor fraction separates from the heated intermediate product, thereby yielding a purified product comprising a final solvent fraction and a final product fraction;
at a second condenser:
condensing the final vapor fraction, thereby yielding a second solvent condensate.

2. The method of claim 1, wherein the raw feed comprises ethanol and cannabis oil.

3. The method of claim 1, wherein the initial solvent fraction is 95 percent ethanol and the initial product fraction is 5% oils.

4. The method of claim 1, wherein the intermediate solvent fraction is 70 percent ethanol and the intermediate product fraction is 30 percent oils.

5. The method of claim 1, wherein the final solvent fraction is 0.5 percent ethanol and the final product fraction is 99.5 percent oils.

6. The method of claim 1, further comprising recirculating a portion of the intermediate product into the first heat exchanger.

7. The method of claim 1, further comprising recirculating a portion of the purified product into the second heat exchanger.

8. The method of claim 1, wherein the first heat exchanger receives the raw feed at an average rate of at least 390 L/hr.

9. The method of claim 1, wherein the second heat exchanger receives the intermediate feed at an average rate of at least 65 L/hr.

10. The method of claim 1, further comprising generating a negative pressure at a solvent-contacting side of the second condenser.

11. A product purification and solvent recovery system comprising:
a raw feed inlet for receiving a raw feed comprising an initial solvent fraction and an initial product fraction;
a first stage including:
a first heat exchanger in fluid communication with the raw feed inlet, wherein the first heat exchanger transfers heat to the raw feed to provide a heated raw feed;
a first vapor liquid separator in fluid communication with the first heat exchanger, wherein the first vapor liquid separator vaporizes at least an intermediate vapor fraction of the initial solvent fraction such that the intermediate vapor fraction separates from the heated raw feed, thereby yielding an intermediate product comprising an intermediate solvent fraction and an intermediate product fraction; and
a first condenser in fluid communication with the first vapor liquid separator, wherein the first condenser condenses the intermediate vapor fraction, thereby yielding a first solvent condensate; and
a second stage including:
a second heat exchanger in fluid communication with the first vapor liquid separator, wherein the second heat exchanger transfers heat to the intermediate product to produce a heated intermediate product;
a second vapor liquid separator in fluid communication with the second heat exchanger, wherein the second vapor liquid separator vaporizes at least a final vapor fraction of the intermediate solvent fraction such that the final vapor fraction separates from the heated intermediate product, thereby yielding a purified product comprising a final solvent fraction and a final product fraction; and
a second condenser in fluid communication with the second vapor liquid separator, wherein the second condenser condenses the final vapor fraction, thereby yielding a second solvent condensate;
at least one solvent discharge outlet in fluid communication with the first condenser and the second condenser for discharging the first solvent condensate and the second solvent condensate; and
a final product discharge outlet in fluid communication with the second vapor liquid separator for discharging the purified product.

12. The system of claim 11, wherein the first stage further includes a recirculation pump between the first vapor liquid separator and the first heat exchanger for recirculating liquid from the first vapor liquid separator to the first heat exchanger.

13. The system of claim 11, wherein the second stage further includes a recirculation pump between the second vapor liquid separator and the second heat exchanger for recirculating liquid from the second vapor liquid separator to the second heat exchanger.

14. The system of claim 11, wherein the first heat exchanger is a plate and frame heat exchanger, a brazed plate heat exchanger, a shell and tube heat exchanger, a spiral heat exchanger, or a plate and shell heat exchanger, and wherein the second heat exchanger is a plate and frame heat exchanger, a brazed plate heat exchanger, a shell and tube heat exchanger, a spiral heat exchanger, or a plate and shell heat exchanger.

15. The system of claim 11, wherein the first condenser is a plate and frame heat exchanger, a brazed plate heat exchanger, a shell and tube heat exchanger, a spiral heat exchanger, or a plate and shell heat exchanger, and wherein the second condenser is a plate and frame heat exchanger, a brazed plate heat exchanger, a shell and tube heat exchanger, a spiral heat exchanger, or a plate and shell heat exchanger.

16. The system of claim 11, wherein the first vapor liquid separator or the second vapor liquid separator is a dished head separator.

17. The system of claim 11, wherein the first vapor liquid separator or the second vapor liquid separator has a mist eliminator.

18. The system of claim 11, wherein the second stage further includes a vacuum pump in fluid communication with the second condenser and venting to atmosphere.

19. The system according to claim 11, wherein the at least one solvent discharge outlet comprises a first solvent condensate outlet in fluid communication with the first condenser and a second solvent condensate outlet in fluid communication with the second condenser.

20. The system according to claim 11, wherein the at least one solvent discharge outlet comprises a single solvent discharge outlet in fluid communication with the first condenser and the second condenser.
